(19) United States
(12) Patent Application Publication
(10) Pub. No.: US 2022/0398482 A1
(43) Pub. Date: Dec. 15, 2022

(54) METHOD FOR SIMULATING A REAL SPIN SYSTEM, MORE PARTICULARLY A NOISY SPIN SYSTEM, BY MEANS OF A QUANTUM COMPUTER

(71) Applicant: HQS Quantum Simulations GmbH, Karlsruhe (DE)

(72) Inventors: Michael MARTHALER, Karlsruhe (DE); Sebastian ZANKER, Karlsruhe (DE); Keith FRATUS, Karlsruhe (DE)

(73) Assignee: HQS Quantum Simulations GmbH, Karlsruhe (DE)

(21) Appl. No.: 17/775,958

(22) PCT Filed: Apr. 12, 2021
(86) PCT No.: PCT/DE2021/100332

§ 371 Date: May 11, 2022

(30) Foreign Application Priority Data
May 30, 2020 (DE) 10 2020 114 575.6

(51) Int. Cl. G06N 10/20; G06N 10/60

(52) U.S. Cl. CPC G06N 10/20; G06N 10/60

(57) ABSTRACT

A method for simulating a noisy spin system using a quantum computer, wherein a real spin system is based on an abstract quantum spin system and at least one physical parameter to be determined is mapped to the abstract quantum spin system. It is characterized by the fact that a simulation algorithm for the abstract quantum spin system is created and the decoherence rates and the corresponding coupling operators of all available qubits of a quantum computer are determined, as well as that the effective decoherence rates of the spins of the abstract quantum spin system are determined and the effective decoherence rates of the spins of the abstract quantum spin system with the spins and the associated decoherence rates of the qubits of a quantum computer are mapped in such a way that the abstract quantum spin system is then simulated on a quantum computer and the at least one physical parameter of the abstract quantum spin system to be determined is determined.

The invention relates to a method for simulating a real, in particular noisy spin system using a quantum computer, wherein a real, in particular noisy spin system is based on an abstract quantum spin system and at least one physical parameter to be determined on the abstract quantum spin system is mapped.

For example, the subsequently published German patent application DE 10 2019 109 816 A1 discloses a method for modeling a system with the aid of a quantum computer. The method is characterized by the fact that the system to be motivated is divided into a bad part of low relevance and a cluster part of high relevance, wherein the low-performing qubits are assigned to a rough description of the bad part and the high-performing qubits are assigned to an exact description of the cluster part.

Furthermore, the subsequently published patent application US 2020/0320240 A1 discloses a method for optimizing the circuit parameters of variable quantum algorithms for the practical use of quantum computer algorithms in the near future. The method is characterized in that, in a first stage, analytical tomography adjustments are carried out for a local cluster of circuit parameters by sampling the observable target function at the quadrature point in the circuit parameters. Optimization can be used to determine the optimal circuit parameters frozen. In a second stage, different clusters of circuit parameters are then optimized in “Jacobi sweeps”, which leads to a monotonically covering fixed-point method. In a third stage, the iteration history of the fixed-point Jacobi method can be used to accelerate the convergence by applying Anderson's acceleration or Pulay's direct inversion of iterative subspace (DIIS).

The review article by Georgescu et al. (Georgescu, lulia M., Sahel Ashhab, and Franco Nori. “Quantum simulation.” Reviews of Modern Physics 86.1 (2014): 153.) shows different approaches to the simulation of quantum mechanical systems, in particular quantum simulation with quantum computers, as well as the most important theoretical and experimental aspects of such quantum simulations.

The functional principle of a quantum computer has been known as a theoretical concept for a long time and has also been implemented in practice for some time. While in conventional digital computers information is represented in bits, which in principle represent switches in an on or in an off position, the information, which is also in principle binary, is represented in the quantum computer by quantum mechanical states. This can usually be the spin of an electron, energy levels of atoms, or the direction of current, charge, or magnetic flux in a superconductor. Regardless of the choice of physical implementation, such a two-state quantum mechanical system is called a qubit.

Most often, the on or off state of a qubit is described in terms of a “spin-up” or “spin-down”, since the possible configurations and/or dynamics of a qubit are comparable to those of a “spin”, in particular in the form of an electron spin or nuclear spins. It is therefore characteristic of such a qubit that a qubit can exist in any combination of these two states “spin up” and “spin down”. Thus, a quantum computer consists of multiple interacting qubits, which are mathematically equivalent to many interacting “spins”.

Viewing this interaction of qubits in the form of a spectrum, this spectrum contains absorption and emission peaks centered within the frequency at which the system absorbs or mimics energy. So ideally this would result in sharp peaks within the spectrum.

However, qubits are very sensitive to errors. In particular, such are caused by the coupling of the qubits to external degrees of freedom. This is often referred to as a decoherence. This decoherence—which is largely described by the decoherence rate γ_{dec} and reflects the accumulation of errors in the quantum computer—leads to a broadening of the absorption and emission peaks within a spectrum.

Such broadened peaks, also known as noisy peaks, also occur in other real spin systems, in particular in nuclear magnetic resonance spectroscopy (NMR), in which the nuclear spin of an atom is examined. Here, too, the spins of the nuclei of the atoms to be examined are dependent on external influences, which also results in decoherence. Therefore, the peak broadening of a real spin system is mathematically comparable to the peaks broadened by decoherence of a qubit system. Other examples of real spin systems to which this applies include electron spin resonance spectroscopy (ESR) or spintronic systems. The quantum state of an ideal spin system is usually described via a wave function |ψ) which is a vector matrix of 2N complex numbers, where N is the number of spins.

The temporal evolution of this state is determined by the Schrödinger equation, wherein this contains the Hamilton operator Hof the system in the form of

$$\frac{\partial }{\partial t} \vert ψ 〉 = - iH \vert ψ 〉 .$$

The Hamilton operator H is a matrix operator acting on the wave functions |ψ), so that in the ideal case, a linear system of 2^{N} coupled differential equations has to be solved.

In contrast to the ideal system, the state of a noisy system cannot be described by such a wave function. Rather, the loss of quantum coherence requires a description in terms of a density matrix, which can be represented in terms of a 2^{N}×2^{N} matrix.

A comparable linear equation of the evolution of such a system over time can, in particular, be described by

$$\frac{\partial }{\partial t} ρ = L ( ρ )$$

where the “Liouville superoperator” is an operator that acts on matrices. The most common form of the “Liouville superoperator” can be written as the “Lindblad equation” as follows:

$$\frac{\partial }{\partial t} ρ = - \frac{i}{ℏ} [ H , ρ ] + {\sum }_{i} {γ}_{i} ( {L}_{i} ρ {L}_{i}^{t} - \frac{1}{2} \{ {L}_{i}^{t} - \frac{1}{2} \{ {L}_{i}^{t} \vert {L}_{i} ρ \} )$$

where H is a Hamilton operator, γᵢ describes the rates at which certain relaxation processes occur, and Lᵢ are so-called coupling operators that describe details of the relaxation processes or details of the coupling of the qubits to the external degrees of freedom. The coupling operators of the qubits are also called real coupling operators. The superoperator defined by the coupling operators is also called the Lindblad superoperator. In the case of spin systems and accordingly also qubits, the coupling operators are commonly given by the Pauli operators σₓ, σ_{y}, σ_{z}, each of which only affects one spin or one qubit. In particular coupling operators are also possible that act on more than one spin or qubit and which can be represented by a product of Pauli operators that act on different qubits or spins.

Because of the relationship

2^{N}×2^{N}=2^{2N}

it follows that simulating a system of N noisy spins is equivalent to simulating twice as many ideal spins. This additional computational effort poses a significant challenge for both classical and quantum computers. The aim of the invention disclosed here is to avoid this computing effort and to reduce or minimize it by using the intrinsic noise of the quantum computer used to simulate a noisy spin system.

This object is achieved by a method for simulating a real, in particular noisy, spin system using a quantum computer according to the applicable claim 1. Advantageous embodiments of the invention can be found in dependent claims.

According to the invention, it is a method for simulating a real spin system, in particular a noisy one, using a quantum computer. The procedure comprises four steps. The decoherence rates and corresponding coupling operators Lᵢ of all qubits present on a quantum chip of a quantum computer are determined. This is done, for example, by gate tomography. In addition, the real spin system to be simulated, e.g. the nuclear spin of a molecule, is converted into a quantum mechanical model, also called abstract spin system or abstract quantum spin system, which contains the physically interesting or relevant physical properties of the spin system to be simulated. At least one physical parameter of the real spin system to be determined is mapped onto the abstract quantum spin system.

Within the framework of the method, the at least one physical parameter of the abstract quantum spin system to be determined is determined, i.e. the at least one physical parameter which was mapped onto the abstract quantum spin system is measured on the abstract quantum spin system or on the quantum computer and thus corresponds to the at least one physical parameter of the real, in particular noisy, spin system on the basis of the mapping carried out beforehand.

The real spin system can be understood, inter alia, as a physical spin system, such as nuclear spins or electron spins, but also optimization problems that can be mapped onto spin systems and other systems that can be mapped onto spin systems.

The physical parameter can be understood, inter alia, as a correlator, a physical variable, a parameter onto which the optimization problem is mapped, a cost function of the optimization, etc. For example, the physical parameter can be a correlator between spin operators, which can be, for example, spin operators of the same lattice sites or atoms or of different lattice sites or atoms. The correlator can be time-independent or time-dependent. Other examples of physical parameters are physical quantities such as magnetization, a magnetic field, an interaction between spins, etc. For example, the cost function can be mapped as the energy of the abstract spin system.

The invention is characterized in that a simulation algorithm is created for the abstract quantum mechanical model of the real spin system to be simulated. This is usually realized by a form of a Hamilton operator with additional terms to describe the decoherence processes. Furthermore, effective decoherence rates Γ_{dec} of the spins of the modeled or abstract quantum spin system is determined.

This is done, for example, using a sequence of quantum gate operators that simulate the temporal dynamics of the abstract model. Typically, such a sequence includes a large number of discrete steps, which in turn contain a certain number of quantum gate operators. The aim of this determination process of the effective decoherence rates is the scaling of the effective decoherence rates of the real, in particular noisy spin system in relation to the intrinsic decoherence rate of the qubits of a quantum computer.

In addition to the effective decoherence rates, the associated effective coupling operators Lᵢ can also be determined, which describe how the abstract spins couple to the effective decoherence rates. Together, effective decoherence rates and effective coupling operators are also referred to as the effective noise model.

The effective coupling operators describe how the effective decoherence rates couple to the abstract spin system, since these operators can differ from the coupling operators of the qubits to the external degrees of freedom, depending on the selected quantum gate decomposition. In particular, it is determined how the effective coupling operators are related to the coupling operators of the qubits. Depending on the selected quantum gate decomposition, the effective coupling operators Lᵢ can also act on several abstract spins and be individual Pauli operators or products of a plurality of Pauli operators.

An algorithm for simulating the dynamics can be implemented, for example, using trotterization

$${e}^{- iHt} \approx {\prod }_{m}^{n} {\prod }_{k} {e}^{- i \frac{{H}_{k} t}{n}}$$

with H=ΣₖHₖ. Each of the exponential operations on the right in turn involves a certain number of quantum gate operators. The applied quantum gate operators depend on the physical realization of the qubits. After determining the effective decoherence rates of the abstract quantum spin system, these are mapped with the previously determined decoherence rates of the qubits of a quantum chip of a quantum computer, whereby mapping is understood to mean the assignment of the simulated spins of the abstract quantum spin system to the qubits of a quantum computer with matching effective decoherence rates and/or “best matches” of the effective decoherence rates with the noise of the real spin system.

In addition to mapping using effective decoherence rates, the effective coupling operators may also be used for mapping. In this case, spins of the abstract quantum spin system are assigned to the qubits of a quantum computer, so that the resulting effective noise model describes the noise of the real spin system as well as possible, i.e. agreement and/or “best match”.

After the mapping, it is now possible to simulate the real spin system on a noisy quantum computer using the simulation algorithm, based on the previously assigned decoherence rates and/or the coupling operators Lᵢ, through the abstract simulation and the read out from the quantum computer.

One advantage of this method is that at the present time a noisy quantum system, in particular noisy quantum computers, are unsuitable for simulations, but these can be used with the aid of the method disclosed here for simulating real spin systems, in particular noisy ones. Another advantage is the fact that such noisy spin systems can hardly or only poorly be simulated on conventional computing machines at the present time.

In order to determine the time that the quantum chip takes to perform a discrete step, it is necessary to count the number of quantum gate operations within the discrete step, since these together correspond to a single time evolution step. The time taken, in turn, determines the noise that occurs during such a step on a quantum computer. Therefore, in an advantageous embodiment, the method provides that the simulated effective decoherence rate of a discrete step consisting of a sequence of N quantum gate operations may be described by the equation

$${Γ}_{dec} = \frac{1}{{t}_{sim}} {\sum }_{i = 1}^{N} {τ}_{i}^{g} {Γ}_{i}^{g}$$

wherein τᵢ^{g} the quantum gate times, Γᵢ^{g} the qubit decoherence rates during the quantum gate and tₛᵢₘ are the simulated duration of such a time evolution step. In the event that the effective decoherence rates vary from one qubit to the next, a separate version of the above equation applies to each individual qubit. Should some quantum gate operations be able to be performed in parallel, the effective number of quantum gate operations may be reduced, thereby reducing the simulated effective decoherence. The effective decoherence rate can be increased by simply applying a trivial quantum gate, i.e. passing time without actually applying a quantum gate operation.

In addition, in an advantageous embodiment of the method, the effective coupling operators Lᵢ are determined. Each qubit couples to the environment with certain coupling operators L^{q}ᵢ, which can be expressed by Pauli operators. This coupling can deviate from the real coupling of a spin system. In a further advantageous embodiment of the method, a connection between the effective Lᵢ and the coupling operator L^{q}ᵢ of the qubits can be generated by rotating the basis, including the states ‘spin up’ and ‘spin down’. It should be noted that large rotations used as part of the quantum gate operations lead to effective transformations of L_{q}ⁱ.

In a further advantageous embodiment of the method, the effective coupling operators are determined by swapping. Swapping is understood here to mean a swapping of super operators, as is described below by way of example. A sequence of decoherence quantum gates implementing a discrete time step may be represented by a sequence of superoperators as follows:

$$G = {e}^{{ℒ}_{1}} {e}^{{ℒ}_{{D}_{1}}} {e}^{{ℒ}_{1}} {e}^{{ℒ}_{{D}_{1}}} ⋯ {e}^{{ℒ}_{N}} {e}^{{ℒ}_{{D}_{N}}}$$

Here are the [symbol] ᵢ the Lindblad superoperators, which describe the gate without decoherence, so-called gate superoperators, and the [symbol] _{D}_{ᵢ} Lindblad superoperators describing the decoherence during the corresponding gate, so-called decoherence superoperators. To determine the effective noise, the decoherence superoperators are swapped right or left and combined. Since they are operators, swapping a decoherence superoperator with a gate superoperator results in a transformation of the gate superoperator. The action of a gate superoperator is described by

$${e}^{{ℒ}_{i}} A = {U}_{i} {AU}_{i}^{†}$$

wherein Uᵢ is a unitary matrix. If a decoherence superoperator is swapped past such a gate, the corresponding coupling operators change according to

$${L}_{{D}_{i}} \to {U}_{j} {L}_{{D}_{i}} {U}_{j}^{†}$$

This allows the effective coupling operators of a sequence of gate operations to be determined.

In another advantageous embodiment of the method, gate operations are used to produce further effective coupling operators by means of the transformations Uᵢ, which can be used to describe the real system or to achieve certain effects, e.g. a certain state of equilibrium of the abstract spin system, but which do not occur natively with the qubits. Additional gate operations can also be introduced for this purpose.

For example, a state of equilibrium at infinite temperature can be reached by randomizing the coupling operators by rotating the base multiple times in different directions.

Since there is no unambiguous solution as to how spins and qubits are assigned to one another, a choice is made in a further advantageous embodiment which optimizes this so-called mapping. The method provides that the optimization problem is formulated in such a way that the effective decoherence rate Γ_{dec}(M) is a function of the mapping M and optimally represents a desired target decoherence rate, such as that of the real system:

$${M}_{opt} = {arg min}_{M} ( \vert {Γ}_{dec} ( M ) - {Γ}_{target} \vert )$$

Instead of a desired rate, the problem can also be reformulated so that the lowest possible effective rate results:

$${M}_{opt} = {arg min}_{M} ( {Γ}_{dec} ( M ) )$$

In physical implementations of quantum computers, the connectivity of the qubits is often limited, for example only neighboring qubits can interact with each other in a two-dimensional arrangement. This is also called interaction and can be taken into account during the mapping process. From this two-dimensional arrangement, linear chains of qubits can always be combined, in which the nearest neighbors can interact with each other, also called an interaction chain.

In a further advantageous embodiment, at least one interaction, in particular an interaction chain, between adjacent qubits is taken into account in the simulation algorithm of the abstract quantum spin system. This is because the algorithm is executed on a large number of qubits, which represent the spins of the real spin system, and the interaction of the qubits leads to noise between the quantum gate operations, with which the effective decoherence rate can be simulated. The interaction can be artificially extended using swap operations between qubits to also represent more complex abstract systems. The effective noise model is further modified by these swapping operations. Efficient simulation algorithms can be defined for an interaction chain using so-called swap networks.

Since there is no unambiguous solution as to where an interaction chain between qubits of a quantum computer is located, a choice has to be made as to which interaction chains of the qubits to use.

In order to optimize this so-called mapping, the method provides that this optimization problem is formulated in such a way that the effective decoherence rate is a function of the mapping:

$${Γ}_{dec} ( {M}_{opt} ) = {min}_{M} {Γ}_{dec} ( M )$$

The invention is then explained in more detail using an embodiment.

In the drawings:

1 is a schematic sequence of an embodiment of the method for simulating a real, in particular noisy, spin system using a quantum computer.

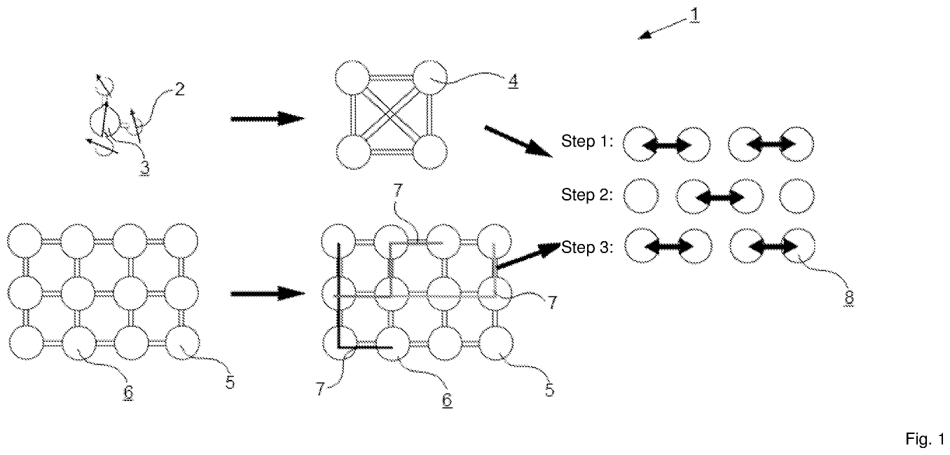

FIG. 1 shows a schematic sequence of an embodiment of the method 1 for the simulation 8 of a noisy real spin system 3 using a quantum computer 6, which includes two work sequences running in parallel. On the one hand, the conversion of the spin system 3 to be simulated into an abstract quantum spin system 4. On the other hand, the detection of all possible qubits 5 and their decoherence rates of a quantum computer 6. First, the real spin system 3 is mapped onto a model, which is described using a spin Hamilton operator. This spin Hamilton operator also contains terms that describe the decoherence of spins 2. Furthermore, all possible interaction chains 7 that enable the simulation 8 of a real system with a specific number of qubits 5 are mapped onto the quantum computer 6.

Each of these interaction chains 7 will generate a specific noise profile for the simulation 8 through the respective decoherence rates. The mapping then takes place, i.e. the selection of the most suitable interaction chain 7 with the most suitable decoherence rates in order to generate the optimal approximation of the abstract quantum spin system 4 and the simulation 8.

A method is thus disclosed above, with which a real, in particular noisy, spin system is simulated using a quantum computer and a high computing effort is avoided or minimized since the intrinsic noise of the qubits of a quantum computer is used for the simulation.

### LIST OF REFERENCE SIGNS

1 Method
2 Spin
3 Spin system
4 Abstract spin system
5 qubit
6 Quantum computer
7 Interaction chain
8 Simulation

1. A method (1) for simulating a real, in particular noisy spin system (3) using a quantum computer (6), wherein a real, in particular noisy spin system (3) on an abstract quantum spin system (4) and at least one physical parameter to be determined is mapped to the abstract quantum spin system (4),
wherein a simulation algorithm for the abstract quantum spin system (4) is created and the decoherence rates and the corresponding coupling operators of all available qubits (5) of a quantum computer (6) are determined, and that the effective decoherence rates of the spins (2) of the abstract quantum spin system (4) and the effective decoherence rates of the spins (2) of the abstract quantum spin system (4) with the spins (2) and the associated decoherence rates of the qubits (5) of a quantum computer (6) are mapped in such a way that the abstract quantum spin system (4) is then simulated on a quantum computer (6) and the at least one physical parameter of the abstract quantum spin system (4) to be determined is determined.

2. The method according to claim 1, wherein effective coupling operators associated with the effective decoherence rates are determined, which are generated by the application of discrete gate operations from the coupling operators of the qubits (5).

3. The method according to claim 1, wherein the effective decoherence rate Γ_{dec} within a time development step tₛᵢₘ determined by means of
$${Γ}_{dec} = \frac{1}{{t}_{sim}} {\sum }_{i = 1}^{N} {τ}_{i}^{g} {Γ}_{i}^{g} ,$$
wherein N is a sequence of quantum gate operations, τᵢ^{g} quantum gate times and Γᵢ^{g} decoherence rate.

4. The method according to claim 1, wherein decoherence superoperators are defined which include the coupling operators of the qubits (5).

5. The method according to claim 1, wherein a swapping of the decoherence superoperators is used to determine the effective coupling operators.

6. The method according to claim 1, wherein the effective coupling operators are transformed by using gate operations.

7. The method according to claim 6, wherein rotations of the qubit basis are used for the transformation.

8. The method according to claim 6 or 7, wherein a certain state of equilibrium is to be reached, in particular for infinite temperature.

9. The method according to claim 1, wherein at least one interaction, in particular an interaction chain (7), between adjacent qubits (5) and/or quantum gates is taken into account in the simulation algorithm of the abstract quantum spin system (4).

10. The method according to claim 1, wherein in order to optimize the mapping of the effective decoherence rates with the decoherence rates of the qubits (5) of a quantum computer (6), the effective decoherence rate Γ_{dec} is a function according to the mapping
$${Γ}_{dec} ( {M}_{opt} ) = {min}_{M} {Γ}_{dec} ( M ) .$$

11. The method according to claim 1, wherein in order to optimize the mapping of the effective decoherence rates with the decoherence rates of the qubits (5) of a quantum computer (6), the effective decoherence rate Γ_{dec}(Mₒₚₜ) is a function according to the mapping
$${M}_{opt} = {arg min}_{M} \vert {Γ}_{dec} ( M ) - {Γ}_{target} \vert .$$
